(19) United States
(12) Patent Application Publication
(10) Pub. No.: US 2015/0321569 A1
(43) Pub. Date: Nov. 12, 2015

(54) GARAGE AND ELECTRICITY SUPPLY SYSTEM

(71) Applicant: PLANET UP INTERNATIONAL L.L.C., Orlando, FL (US)

(72) Inventor: José Eduardo Muait Jardim, Rio de Janeiro (BR)

(73) Assignee: PLANET UP INTERNATIONAL L.L.C., Orlando, FL (US)

(21) Appl. No.: 14/440,911

(22) PCT Filed: Dec. 6, 2012
(86) PCT No.: PCT/BR2012/000501

§ 371 Date: May 6, 2015

(51) Int. Cl. B60L 11/18; E04H 6/02

(52) U.S. Cl. CPC B60L 11/1818; E04H 6/02

(57) ABSTRACT

Invention patent belonging to the field of equipment used to store and supply electricity to electricity-powered vehicles comprising a fixed structure (1) that includes side (2), front (3) and rear walls, in which the front wall has an opening (4) for the ingress and egress of the electrical vehicles (5), and in which said structure (1) has a weather-protection roof (6) made up of plates (7) of photoelectric solar cells for capturing sunlight to generate electricity or devices for generating electricity from wind power, and in which said structure (1) contains a plurality of sockets (8) for powering the batteries of the parked electrical vehicles. The mobile structure (9) has a weather-protection roof (10) made up of plates (11) of photoelectric solar cells for capturing sunlight to generate electricity or devices for generating electricity from wind power, in which said structure has a plurality of sockets (12) for powering the batteries of the parked electrical vehicles (13).

This descriptive report discusses the invention patent for an innovative garage and electricity supply system, namely a system for parking electrical bicycles or other battery-charged vehicles with a recharge differential that uses solar or wind energy, a system which can be in a fixed location or segmented in the mobile version and adapted to urban spaces according to the specifics of the environment. Its design is innovative and has important technological and functional improvements, according to the most modern engineering designs and in compliance with the required norms and specifications, with its own characteristics and the fundamental requirements of novelty and inventive activity, resulting in a series of real and extraordinary technical, practical and economic advantages.

As technicians in the matter are aware, there are currently no parking lots in the market that provide the two functions of the storage and supply of electricity-powered vehicles together.

Considering this, over time studies were conducted seeking to eliminate these problems, and the result was development of this system, which allows the design of fixed and mobile locations. Now it is possible to store and supply electricity to electricity-powered vehicles and thus obtain an integrated set with real possibilities for economic industrialization, minimizing costs, assembly time and labor expenses, in addition to a precise effect of assembly, with better results and a higher standard of safety.

One of the objectives of this patent, therefore, is to provide a joint system which, at a fixed location, will increase the physical capacity of a parking lot with individual bays that can receive and recharge more vehicles and thus offer auxiliary services, such as maintenance, etc.

The fixed system has a basic structure for storing, recharging and protecting electricity-powered vehicles, a roof structure that has devices to capture sunlight or wind, structured cabling to channel the captured energy to vehicles that are being charged, charging regulators, and an area for maintenance and conversion of electrical vehicles, which may be independent or form part of the already-existing parking area.

The mobile version, which is the object of this patent, increases the area where the system can be used, making various points of parking/recharging along the most commonly used roads of large cities available. The mobile variation consists of building small parking modules so that the reduction in physical space will minimize interference in urban spaces, or even incorporate their characteristics in order to camouflage it. The basic structure of the mobile station can be disassembled, it has a roof with devices to capture solar or wind energy, a rechargeable battery pack to accumulate the captured energy, structured cabling to channel the captured energy to the vehicles being charged, and charging regulators.

For countries and cities where incorporating the concept of sustainability is still growing, the garage and electricity supply system that is the object of this patient is initially sustained by an incentive to encourage alternative transportation. The idea is to generate experimentation with electrical bicycles and to expand the consumption fever surrounding the product with sustainability arguments.

With the intention of creating partnerships with the government, the mobile version of the system should be presented, offering free use of electrical bicycles at strategic points on urban routes. Each module will contain its vehicles which, after use, must be returned to that module, or to any other module.

For these same countries and cities, the system may structure recharging for electricity-powered police vehicles and other urban management centers.

In the future, after this means of transportation has been adopted by a considerable number of people, the public experiment may give rise to a traditional model, including consumers' privately owned vehicles, and even to outfitting the vehicles with a satellite-tracking system and live transmission of images captured by a built-in camera.

These and other objectives are attained with a fixed structure that includes side, front and back walls, with the front wall providing an opening for the entry and exit of electrical vehicles. Said structure will have a weather-protection roof comprised of photoelectric solar cells to capture sunlight to generate electricity, or devices to generate electricity using wind, and internally this structure will have a plurality of sockets to supply the batteries in the parked electrical vehicles.

The mobile structure includes a weather-protection roof made of photoelectric solar cells to capture sunlight to generate electricity, or devices to generate electricity using wind energy, which structure will have a plurality of sockets to supply the batteries of the parked electrical vehicles.

Solar cells, also called photoelectric cells or photovoltaic cells, are solid state electrical devices that convert light directly into electricity through the photovoltaic effect.

The groups of cells used to make solar modules used to capture energy from sunlight are known as solar panels or solar plates. The energy generated by these solar modules is called photovoltaic solar energy.

Wind energy may be considered one of the most promising natural sources of energy, mainly because it is renewable, meaning that it does not run out, it is clean, widely distributed globally, and if it is used to replace sources of fossil fuels it will help to reduce the greenhouse gas effect. In countries such as Brazil, which has a huge watershed, wind energy might become important in the future, because it does not consume water, which is an increasingly scarce asset that is also increasingly controlled. In countries with a small watershed, wind energy is already taking on a fundamental role as perhaps the only clean and efficient energy in those locations. Beyond the environmental question, wind turbines have the advantage of being used both in connection to electricity networks, as well as in isolated locations, and building transmission lines is not necessary to supply certain regions that have windmills.

As a complement to this description, in order to better understand the characteristics of this patent, and in accordance with a preferential practical realization of it, attached hereto is a set of drawings showing, by way of example but not limited, to the following:

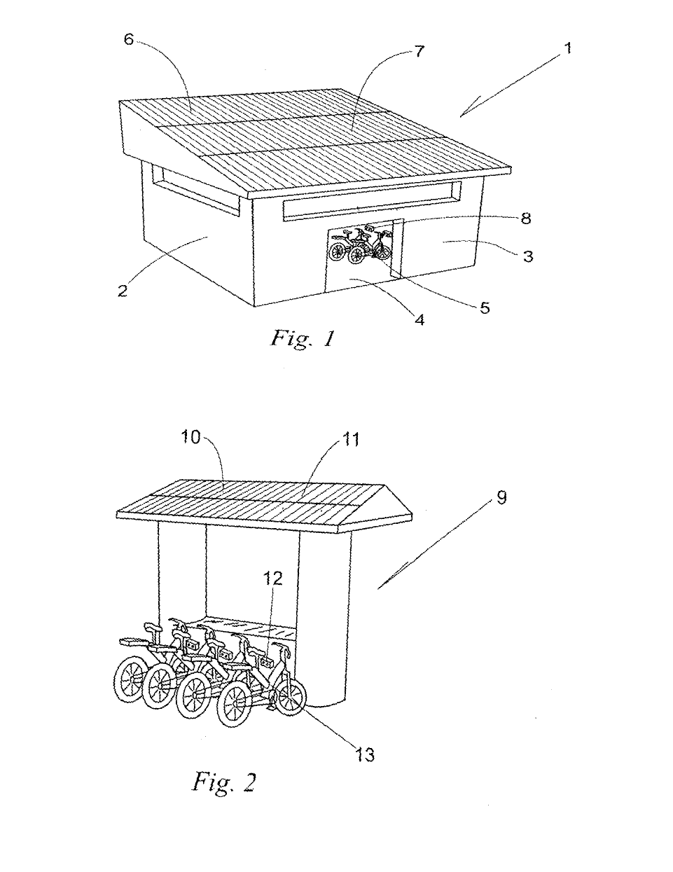

FIG. 1 shows a view of a fixed garage;

FIG. 2 shows a view of a mobile garage;

According to the figures mentioned above and in their details, the garage and electricity supply system that is the object of this patent is comprised of a fixed structure (1) that includes lateral walls (2), frontal walls (3) and back walls (4) for the entry and exit of electrical vehicles (5), with that structure having (1) a weather-protection roof (6) comprised of plates (7) of photoelectric solar cells to capture sunlight for the generation of electricity, or devices to generate electricity from wind energy, with that structure (1) having, internally, a plurality of sockets (8) to supply the batteries of the parked electrical vehicles.

The mobile structure (9) is comprised of a weather-protection roof (10) that is made of plates (11) of photoelectric solar cells to capture sunlight for the generation of electricity or devices for the generation of electricity through wind energy, with said structure having a plurality of sockets (12) to supply the batteries of the parked electrical vehicles (13).

There is no knowledge of any garage and electricity supply system that combines all of the construction and functional characteristics listed above, and that, directly or indirectly, is or was as effective regarding the system that is the object of this patent.

Having described and illustrated this invention, it must be understood that it might undergo countless modifications and variations in its method of realization, although such modifications and variations will not stray from the spirit and scope of the invention, as defined in the claims.

1. “GARAGE AND ELECTRICITY SUPPLY SYSTEM,” characterized by the fact that it is comprised of a fixed structure (1) that includes lateral walls (2), front (3) and rear walls, with the front wall containing an opening (4) for the entry and exit of electrical vehicles (5), with that structure (1) having a weather-protection roof (6) comprised of plates (7) of photoelectric solar cells to capture sunlight to generate electricity or devices to generate electricity by means of wind energy, with such structure (1) having internally a plurality of sockets (8) to supply the batteries of the parked electrical vehicles;

2. “GARAGE AND ELECTRICITY SUPPLY SYSTEM,” characterized by the fact that it is comprised of a mobile structure (9) that includes a weather-protection roof (10) comprised of plates (11) of photoelectric solar cells to capture sunlight to generate electricity or devices to generate electricity by means of wind energy, with such structure having a plurality of sockets (12) to supply the batteries of the parked electrical vehicles (13).
